(19) United States
(12) Patent Application Publication
(10) Pub. No.: US 2003/0006662 A1
(43) Pub. Date: Jan. 9, 2003

(54) DEVICE AT THE END WINDING REGION IN A ROTATING ELECTRIC MACHINE

(76) Inventors: PETER CARSTENSEN, HUDDINGE (SE); MATS LEIJON, VASTERAS (SE); JAN-ANDERS NYGREN, VASTERAS (SE); LARS GERTMAR, VASTERAS (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/297,607

(22) PCT Filed: Nov. 4, 1997
(86) PCT No.: PCT/SE97/01843

(30) Foreign Application Priority Data
Nov. 4, 1996 (SE) 9604033-2

(51) Int. Cl. H02K 1/00; H02K 3/00

(52) U.S. Cl. 310/179; 174/DIG. 13

(57) ABSTRACT

A device for mechanically securing and controlling the potential of winding cables (10) outer semiconducting layers (14) in the end windings region of the stator (2) of a rotating high-voltage electric machine comprises spacers (12) of resilient, electrically conducting material arranged between the semi-conducting outer layers (14) of adjacent winding cables (10, 10′, 10″) Positioning devices (16, 18) are arranged to secure the cables in relation to each other with the outer layers in contact with the spacers. Means are also provided to connect the cables outer semiconducting layers and spacers with a reference potential (28)

The present invention relates to a device for mechanically securing and controlling the potential of winding cables in the coil end part of the stator of a rotating high-voltage electric machine.

The invention is thus applicable to rotating electric machines such as synchronous machines, dual-fed machines, outerpole machines, synchronous flow machines and applications in static current converter cascades. The machines are in the first place intended to be used as generators for connection to power networks. The machines are intended to be used at high voltages, in excess of 10 kV. A typical operating range may be voltages from 36 kV up to 800 kV. This is made possible by using high-voltage insulated electric conductors for the stator winding, in the following called winding cables, with solid insulation similar to cables for transferring electric power, e.g. XLPE-cables. The cable is also provided with an outer semi-conducting layer with the help of which its outer potential is defined. The high voltage cables thus enclose the electrical field within the windings. Such an insulated conductor or cable is flexible and it is of a kind which is described more in detail in the PCT applications SE97/00874 and SE97/00875. Additional descriptions of the concerned insulated conductor or cable can be found in the PCT applications SE 97/009001, SE 97/00902 and SE97/00903.

Larger machines have conventionally been designed for voltages in the range 6-30 kV. This usually implies that a generator is connected to the power network via a step-up transformer. The voltage level of the power network can be in the range of approximately 100-400 kV. In such conventional generator designs the stator windings are constructed so that their outer surfaces are kept at ground potential within the stator stack, whereas the surface potential in the end winding regions is not controlled.

The present invention relates to electric machines, intended for direct connection to a power network without intermediate transformers. Due to the operation at high voltages it is an advantage to control the potential of the winding cables in the end winding.

The windings of such machines can be made from flexible cables. At the end windings, the cables can have a tendency to vibrate, which can cause wear against adjacent cables and result in damage to the outer semi-conducting layer of the cables.

The object of the present invention is therefore to provide a device for controlling the surface potential of the winding in the end winding region of the stator in a rotating high-voltage electric machine and simultaneously provide mechanical securing or support of the cables, in order to avoid damaging the cables by wear against adjacent cables in end winding region.

This is achieved with a device as defined in claim 1.

By using this device, the surface potential in the end winding region is controlled as required ingin high-voltage machines, as well as the necessary suppression of vibrations in the winding cables.

According to a preferred embodiment of the device according to the invention, the spacer is arranged in the area of the coil-end loop situated furthest out from the stator, i.e. the spacer is arranged in the part of the end winding that is most easily accessible.

According to a second advantageous embodiment of the device according to the invention, the spacer is made of a conducting rubber material. It thus serves to electrically connect the outer semiconducting layers of the cables as well as suppressing vibrations.

According to yet another advantageous embodiment of the invention, the resilient material contains a suitable additive in powder form so that a desired control of the potential can be achieved by adjustment of the electrical conductivity.

The additive material may be selected from graphite carbon, such as soot or carbon black, or a metallic powder material based on a metal with good electrical conductivity, such as silver, gold, copper, nickel or aluminium. Other feasible powder materials are ceramic powder based on borides, such as titanium di-boride, zirconium di-boride, carbides, such as tantalum carbide, silicon carbide, tungsten carbide, zirconium carbide, nitrides such as zirconium nitride, titanium nitride, or oxides, such as vanadium tri-oxide, titanium oxide, magnetite, zinc oxide, iron(III)oxide, as well as organo-metallic compounds such as metal phthalocyanide.

In certain special embodiments it may be advantageous to use powder material having a pronounced field-dependent electrical conductivity. Examples of such materials are silicon carbide, zinc oxide, and iron(III)oxide, chromium(III)oxide as an additive.

The additive material may consist of one of the materials listed above or mixtures of two or more of these powders. The electrical conductivity of the resilient material can be influenced by the composition of the powder material, particle size distribution, as well the quantity mixed in and the manner in which it is distributed in the resilient material.

Decisive for the choice of powder material is its electrical conductivity and, if appropriate, the field dependence of the conductivity and the chemical compatibility of the powder material with the resilient material and other additives under the circumstances prevailing during manufacture and use.

According to other advantageous embodiments of the device according to the invention the positioning device comprises a clamping strap to clamp the winding cables together in pairs. The clamping straps may be made of electrically conducting material or of insulating material. The outer semiconducting layer of the cable situated furthest out from the stator in the end winding region is suitably galvanically connected to the reference potential, in practice the ground reference of the machine. If the clamping strap is electrically conducting the cables beneath are connected to ground potential via their semi-conducting outer layer, the clamping arrangement and the spacer, whereas if the clamping straps are of electrically insulating material, the semi-conducting outer layer of the cables beneath are connected to ground potential only through the spacers.

In the high-voltage machines described it is important to avoid partial discharge. For certain types of machines, therefore, a strong or efficient grounding of the outer semiconducting layer ot the winding cables is required via low-resistive connection to ground potential. In other cases a more high-resistive electric connection of the winding cables may be sufficient. In the device according to the invention, therefore, spacers with suitable conductivity for the application in question and clamping straps of either insulating or conducting material may be chosen.

In order to further explain the invention an embodiment will be described in more detail by way of example in the following, with reference to the accompanying drawings in which

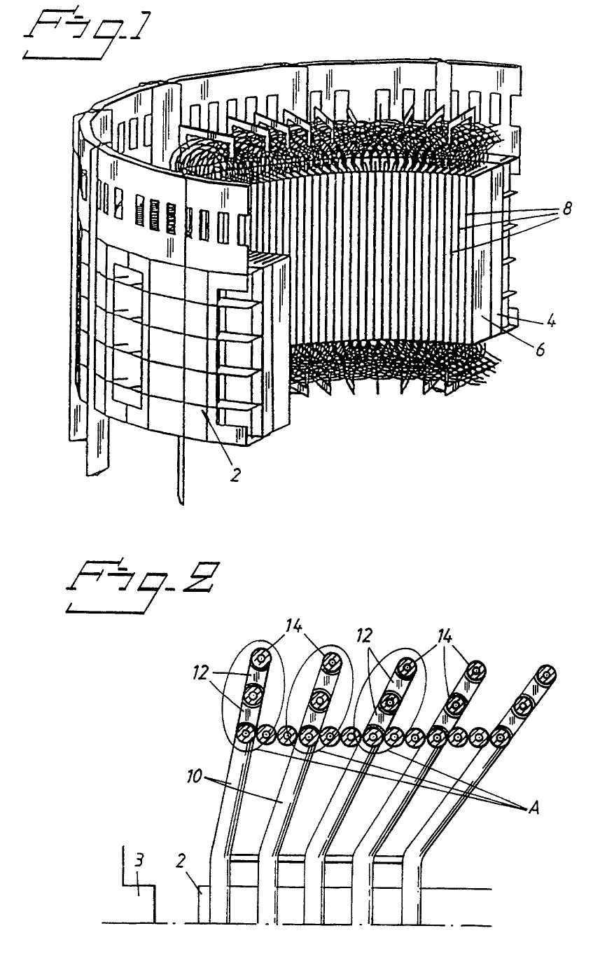

FIG. 1 shows a part of the stator system in a high-voltage machine of the present type, with the rotor removed,

FIG. 2 shows the placing of the spacers in the end winding region seen from “inside” the coil end,

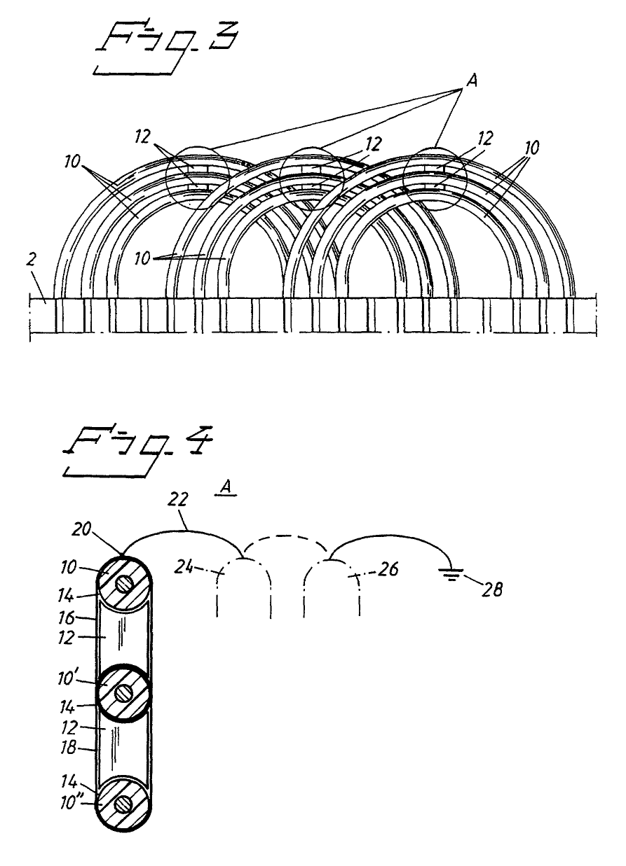

FIG. 3 shows the placing of the spacers seen from the rotor, and

FIG. 4 illustrates the mechanical securing of the cables and spacers with securing means of the clamping-strap kind.

FIG. 1 shows a part of the stator frame 2. From a yoke part 4 of the stator core, situated radially outermost, a number of teeth extend radially in towards the rotor with, between the teeth, a corresponding number of slots 8 in which the stator winding is applied.

FIG. 2 shows a simplified view of the upper end winding region of the stator according to FIG. 1, seen from inside the end winding. The rotor is indicated at 3. Winding cables 10, forming the winding, extend in a loop from one slot in the stator 2 and down into another slot in the stator. Spacers 12 are arranged between the cables 10 in the parts running substantially horizontally in the drawing, see also FIG. 3. The spacers 12 are made of a resilient, electrically conducting material and also serve to support or mechanically secure the cables in the end winding, as described in more detail below. A suitable material for the spacers 12 is conducting rubber and their extension in the longitudinal direction of the cables is typically up to 10 cm. The spacers 12 are arranged between the winding cables in the parts situated furtherst away from the stator 2 so that they are as accessible as possible.

The cables 10 have an outer, semi-conducting layer 14 and spacers 12 are arranged between adjacent cables 10 in contact with the outer layer 14 of the cables 10, see FIG. 4. The outer layers 14 of the cables will therefore also be connected electrically and a connection is led from the outer layer 14 on the cable situated furtherst out from the stator 2, to reference potential, in practice ground potential.

The electrical conductivity of the rubber material in the spacers 12 can be varied by mixing in a higher or lower content of an additive such as carbon or carbon black. An increased quantity of carbon will result in increased conductivity. The conductivity can therefore be controlled so that the desired potential is achieved.

FIG. 4 shows the part A circled in in FIGS. 2 and 3, on a larger scale. Three winding cables 10, 10′, 10″ are thus shown with intermediate spacers 12 of conducting rubber. The cables 10 and 10′ are clamped together by a clamping strap 16 and the cables 10′ and 10″ are clamped together by a clamping strap 18. The clamping strap 16 thus clamps the cables 10 and 10′ against an intermediate spacer 12 which prevents the outer semi-conducting layer 14 of the cables from becoming worn against each other, suppresses vibrations in the cables, and finally connects the semi-conducting outer layers 14 of the cables 10 and 10′ to each other electrically. The clamping strap 18 clamps the cables 10′ and 10″ in the same way. This consecutive clamping together of adjacent cables in pairs continues until all cables in the end winding region have been secured.

The clamping straps 16, 18 may be of conducting material or of insulating material. If the clamping straps 16, 18 are of conducting material, the outer semi-conducting layer 14 of adjacent winding cables 10 will be electrically connected through the clamping straps 16 and also through the conducting rubber spacers 12. If the clamping straps 16, 18 are of insulating material, the outer layer 14 of adjacent cables will be connected only through the spacers.

An electric conductor 22 is connected to the outer part of the cable 10, situated furthest out from the stator end, or to the outer part of the clamping strap 16, if this is of conducting material, uppermost in FIG. 4 at 20. This conductor 22 electrically connects several cable units clamped together in similar manner, indicated at 24 . . . 26, in order to connect all clamped bundles of cables to ground potential at 28. The ground potential can suitably be defined as the outer casing of the machine.

Numerous variants and modifications of the embodiment described above by way of example are of course possible. In this example, for instance, the winding cables are clamped together consecutively two by two. The cables may of course be clamped together in some other way, e.g. three by three. The extension of the spacers in the longitudinal direction of the cable can also be varied depending on the requirements of the particular application.

1. A rotating electric machine for high voltages comprising a stator (2), a rotor and windings, where the windings comprise high voltage cables with outer semiconducting layers enclosing the electrical field within the windings, characterized in that a device for mechanically securing and controlling the potential of the outer semiconducting layer (14) of the cables (10) in the end winding region of the stator is arranged, which device comprises spacers (12) of resilient, electrically conducting material which are arranged between the semi-conducting outer layer (14) of adjacent winding cables, and that positioning devices (16, 18) are arranged to secure the cables (10, 10′, 10″) relative to each other with the outer layers in contact with the spacers, providing connection between the cable outer semiconducting layers and a reference potential.

2. A rotating electrical machine as claimed in claim 1, characterized in that the length of the spacer is only a fraction of the length of the cable in an end winding loop.

3. A rotating electrical machine as claimed in claim 1 or claim 2, characterized in that the spacer is arranged in the area of the end winding loop situated furthest out from the stator.

4. A rotating electric machine as claimed in any of claims 1-3, characterized in that the spacer is made of a conducting rubber material.

5. A rotating electric machine as claimed in claim 4, characterized in that the conductivity of the rubber material may be varied by mixing in suitable additive material in order to achieve the desired potential control.

6. A rotating electric machine as claimed in claim 5, characterized in that the additive material is in powder form and consists of one or more materials selected from a group consisting of graphite carbon, metal with good conductivity, ceramic powder and organo-metallic compounds.

7. A rotating electric machine as claimed in claim 6, characterized in that the additive material consists of a material having a pronounced field-dependent electrical conductivity.

8. A rotating electric machine as claimed in any of claims 1-7, characterized in that the positioning device comprises a clamping strap to clamp the winding cables together in pairs.

9. A rotating electric machine as claimed in any of claims 1-8, wherein the winding cables are arranged in slots in the stator, characterized in that a first clamping strap is arranged to clamp the first and second cables from a stator slot, together with a spacer applied between the cables, a second clamping strap is arranged to clamp the second and third cables from the stator slot, together with a spacer applied between the cables, a third clamping strap is arranged to clamp the third and fourth cables from the stator slot, together with a spacer applied between the cables, etc. until all cables in the stator slot are clamped together.

10. A rotating electric machine as claimed in claim 8 or claim 9, characterized in that the clamping straps are made of electrically conducting material.

11. A rotating electric machine as claimed in claim 8 or claim 9, characterized in that the clamping straps are made of insulating material.

12. A rotating electric machine as claimed in any of the claims 1-11, characterized in that the high voltage cable is flexible and comprises one or more current-carrying conductor, wherein around each conductor there is arranged an inner layer with semiconducting properties and around the inner layer there is arranged a solid insulating part and around the insulating part there is arranged an outer layer with semiconducting properties.

13. A rotating electric machine as claimed in any of the claims 1-12, characterized in that the winding thereof is designed for a voltage suitably in excess of 36 kV, and preferably up to very high voltages, such as 400 kV to 800 kV.
